(19) United States
(12) Patent Application Publication
(10) Pub. No.: US 2026/0186350 A1
(43) Pub. Date: Jul. 2, 2026

(54) ELECTRONIC DEVICE

(71) Applicant: Innolux Corporation, Miaoli County (TW)

(72) Inventors: Hung-Kun Chen, Miaoli County (TW); Cheng-Tai Kang, Miaoli County (TW); Ssu-Ting Lin, Miaoli County (TW)

(73) Assignee: Innolux Corporation, Miaoli County (TW)

(21) Appl. No.: 19/428,325

(22) Filed: Dec. 22, 2025

(30) Foreign Application Priority Data
Jan. 2, 2025 (CN) 202510005171.1

(51) Int. Cl. G02F 1/1339; G02F 1/1362

(52) U.S. Cl. CPC G02F 1/13396; G02F 1/136286

(57) ABSTRACT

An electronic device includes first and second substrates, a display medium layer, a plurality of gate lines, a plurality of data lines, and first and second spacer groups. The display medium layer has a minimum thickness and a maximum thickness. The first and second spacer groups are adjacently disposed along a first direction and have a same spacer arrangement. The first and second spacer groups respectively include first and second spacing units overlapped with a first gate line. In the first direction, a distance between the first and second spacing units is less than a reference dimension m, m=k*y*[ln(t*d)+t/y], wherein k is equal to the minimum thickness divided by the maximum thickness, y is a size of a sub-pixel in a second direction, t is a thickness of the first substrate, and d is the minimum thickness.

### CROSS-REFERENCE TO RELATED APPLICATION

This application claims the priority benefit of China application serial no. 202510005171.1, filed on Jan. 2, 2025. The entirety of the above-mentioned patent application is hereby incorporated by reference herein and made a part of this specification.

### BACKGROUND OF THE DISCLOSURE

### Technical Field

The disclosure relates to an electronic device, and in particular to an electronic device including a spacing unit.

### Description of Related Art

In recent years, there is a demand for thinner electronic devices (e.g., display devices). To achieve thinness, the substrate undergoes a thinning treatment. The display panel assembled from the thinned substrate is more likely to deform and produce significant color unevenness, such as mura, thus affecting the display quality of the electronic device.

### SUMMARY

The disclosure provides an electronic device that may alleviate the issue of mura.

In an embodiment of the disclosure, an electronic device includes a first substrate, a second substrate, a display medium layer, a plurality of gate lines, a plurality of data lines, a first spacer group, and a second spacer group. The second substrate is opposite to the first substrate. The display medium layer is disposed between the first substrate and the second substrate and has a minimum thickness and a maximum thickness. The plurality of gate lines are disposed on the first substrate and extending along a first direction. The plurality of gate lines include a first gate line. The plurality of data lines are disposed on the first substrate and extending along a second direction, wherein the plurality of gate lines are intersected with the plurality of data lines to define a plurality of sub-pixels. The first direction and the second direction are different. The first spacer group and the second spacer group are disposed between the first substrate and the second substrate. The first spacer group and the second spacer group are adjacently disposed along the first direction and have a same spacer arrangement. The first spacer group includes a first spacing unit overlapped with the first gate line. In the first spacer group, the first spacing unit has a first order on the first gate line. The second spacer group includes a second spacing unit overlapped with the first gate line. In the second spacer group, the second spacing unit has a first order on the first gate line. In the first direction, a first distance between the first spacing unit and the second spacing unit is less than a reference size m, m=k*y*[ln(t*d)+t/y], wherein k is equal to the minimum thickness of the display medium layer divided by the maximum thickness, y is a size of one of the plurality of sub-pixels in the second direction, t is a thickness of the first substrate, d is the minimum thickness of the display medium layer, and m, y, t, and d have a same unit.

In order to make the aforementioned features and advantages of the disclosure more comprehensible, embodiments accompanied with figures are described in detail below.

### BRIEF DESCRIPTION OF THE DRAWINGS

FIG. 1 is a schematic top view of an electronic device according to some embodiments of the disclosure.

FIG. 2A and FIG. 2B are cross-sectional schematic views corresponding to section line I-I′ and section line II-II′ in FIG. 1, respectively.

FIG. 3 to FIG. 5 are respectively partial top views of three electronic devices according to some embodiments of the disclosure, respectively illustrating three spacer groups and a plurality of sub-pixels thereunder.

### DESCRIPTION OF THE EMBODIMENTS

Reference will now be made in detail to the exemplary embodiments of the disclosure, and examples of the exemplary embodiments are illustrated in the accompanying drawings. Wherever possible, the same reference numerals are used in the figures and the descriptions to refer to the same or similar portions.

Throughout the disclosure, certain words are used to refer to specific elements in the specification and the claims. Those skilled in the art should understand that electronic device manufacturers may refer to the same elements by different names. The specification does not intend to distinguish between elements having the same function but different names. In the following specification and claims, the words “contain” and “include” and the like are open-ended words, and therefore should be interpreted as “including but not limited to . . . .”

The directional terms mentioned herein, such as “upper”, “lower”, “front”, “rear”, “left”, “right”, etc., refer to the directions of the drawings. Accordingly, the directional terms used are illustrative, not limiting, of the disclosure. In the drawings, each drawing depicts general features of methods, structures, and/or materials used in specific embodiments. However, the drawings should not be interpreted as defining or limiting the scope or nature encompassed by the embodiments. For example, the relative sizes, thicknesses, and locations of various layers, regions, and/or structures may be reduced or exaggerated for clarity.

When one structure (or layer, element, or substrate) described in the disclosure is located on/above another structure (or layer, element, or substrate), it may mean that the two structures are adjacent and directly connected, or may mean that two structures are adjacent rather than directly connected. Indirect connection means that there is at least one intermediary structure (or intermediary layer, intermediary element, intermediary substrate, or intermediary spacer) between two structures. The lower surface of one structure is adjacent to or directly connected to the upper surface of the intermediary structure, and the upper surface of the other structure is adjacent to or directly connected to the lower surface of the intermediary structure. The intermediary structure may be formed by a single-layer or multi-layer physical structure or a non-physical structure, and there is no limit. In the disclosure, when a structure is disposed “on” another structure, it may mean that a certain structure is “directly” on another structure, or that a certain structure is “indirectly” on another structures, that is, there is at least one structure sandwiched between a certain structure and another structure.

The terms “about”, “substantially”, or “essentially” are generally interpreted as within 10% of the given value or range, or interpreted as within 5%, 3%, 2%, 1%, or 0.5% of a given value or range. Moreover, the terms “range from a first value to a second value” and “range between a first value and a second value” mean that the range includes the first value, the second value, and other values therebetween.

Words such as “first” and “second” used in the specification and claims are used to modify elements, which do not themselves imply and represent that the (or these) elements have any previous ordinal numbers, nor do they imply an order of a certain element with another element, or an order in manufacturing methods. These ordinal numbers are used to clearly distinguish an element having a certain designation from another element having the same designation. The same wording may be not used in the claims and the specification. Accordingly, the first member in the specification may be the second member in the claims.

The electrical connection or coupling described in the disclosure may both refer to direct connection or indirect connection. In the case of a direct connection, the terminals of elements on two circuits are connected directly or to each other by a conductor segment. In the case of indirect connection, there are switches, diodes, capacitors, inductors, resistors, other suitable elements, or a combination of the above elements between the terminals of the elements on the two circuits, but the disclosure is not limited thereto.

In the disclosure, the thickness, length, and width may be measured using an optical microscope (OM), and the thickness or width may be measured using a cross-sectional image in an electron microscope, but the disclosure is not limited thereto. In addition, any two values or directions used for comparison may have certain errors. Moreover, the phrases “a given range is from a first value to a second value”, “a given range falls within the range from a first value to a second value”, or “a given range is between a first value and a second value” mean that the given range includes the first value, the second value, and other values therebetween. If the first direction is perpendicular to the second direction, the angle between the first direction and the second direction may be between 80 degrees and 100 degrees; if the first direction is parallel to the second direction, the angle between the first direction and the second direction may be between 0 degrees and 10 degrees.

Unless otherwise defined, all terms (including technical and scientific terms) used herein have the same meaning as commonly understood by those skilled in the art to which this disclosure belongs. It may be understood that these terms, such as those defined in commonly used dictionaries, should be interpreted as having a meaning consistent with the background or context of the related techniques and the disclosure, and should not be interpreted in an idealized or overly formal manner, unless otherwise defined in the embodiments of the disclosure.

In the disclosure, an electronic device may include a light-emitting device, a display device, a backlight device, an antenna device, a packaging device, a sensing device, or a tiling device, but the disclosure is not limited thereto. The electronic device may be a bendable or flexible electronic device. The display device may be a non-self-luminous display device or a self-luminous display device. The backlight device may include, for example, liquid crystal, light-emitting diode, fluorescence, phosphor, quantum dot (QD), other suitable display media, or a combination of the above. The antenna device may include, for example, a reconfigurable intelligent surface (RIS), a frequency selective surface (FSS), a radio frequency filter (RF-Filter), a polarizer, a resonator, or an antenna, etc. The antenna may be a liquid-crystal-type antenna or a varactor diode antenna. The sensing device may be a sensing device sensing capacitance, light, heat energy, or ultrasonic waves, but the disclosure is not limited thereto. In the disclosure, the electronic device may include an electronic element, and the electronic element may include a passive element and an active element, such as a capacitor, a resistor, an inductor, a diode, a transistor, etc. The diode may include a light-emitting diode, a varactor diode, or a photodiode. The light-emitting diode may include, for example, an organic light-emitting diode (OLED), a mini LED, a micro LED, or a quantum dot LED, but the disclosure is not limited thereto. The tiling device may be, for example, a display tiling device or an antenna tiling device, but the disclosure is not limited thereto. It should be noted that the electronic device may be any arrangement and combination of the above, but the disclosure is not limited thereto. The packaging device may be applicable to a wafer-level packaging (WLP) technique or a panel-level packaging (PLP) technique, such as a packaging device of a chip-first process or a chip-last process. In addition, the shape of the electronic device may be rectangular, circular, polygonal, a shape having curved edges, or other suitable shapes. The electronic device may have a peripheral system such as a driving system, a control system, and a light source system to support a display device, an antenna device, a wearable device (for example, including augmented reality or virtual reality), a vehicle-mounted device (for example, including a car windshield), or a tiling device.

It should be noted that, in the following embodiments, without departing from the spirit of the disclosure, features in several different embodiments may be replaced, reorganized, and mixed to complete other embodiments. As long as the features of the various embodiments do not violate the spirit of the disclosure or conflict each other, they may be mixed and matched arbitrarily.

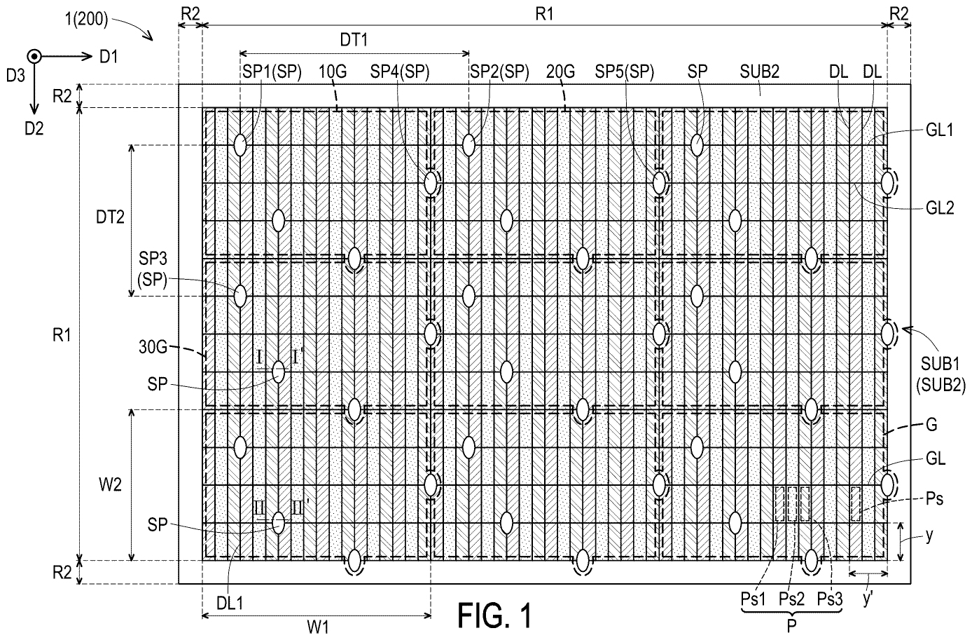

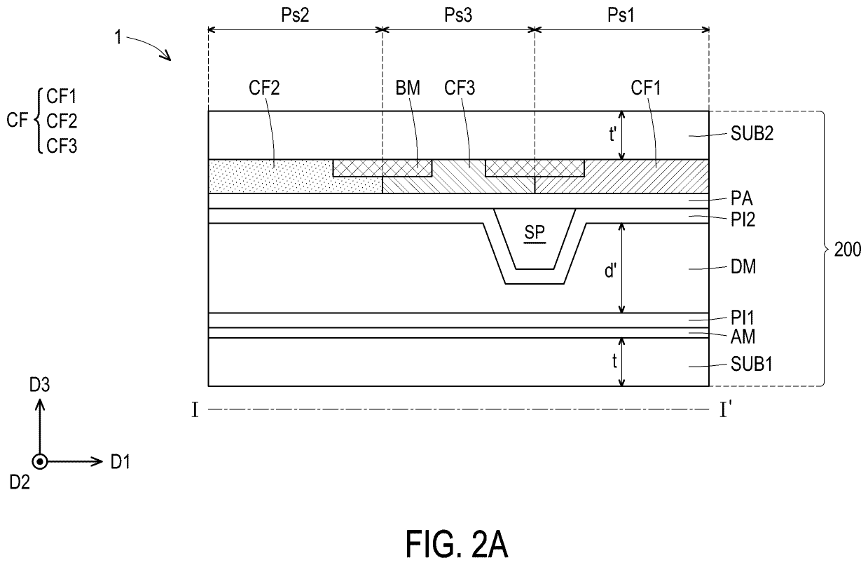

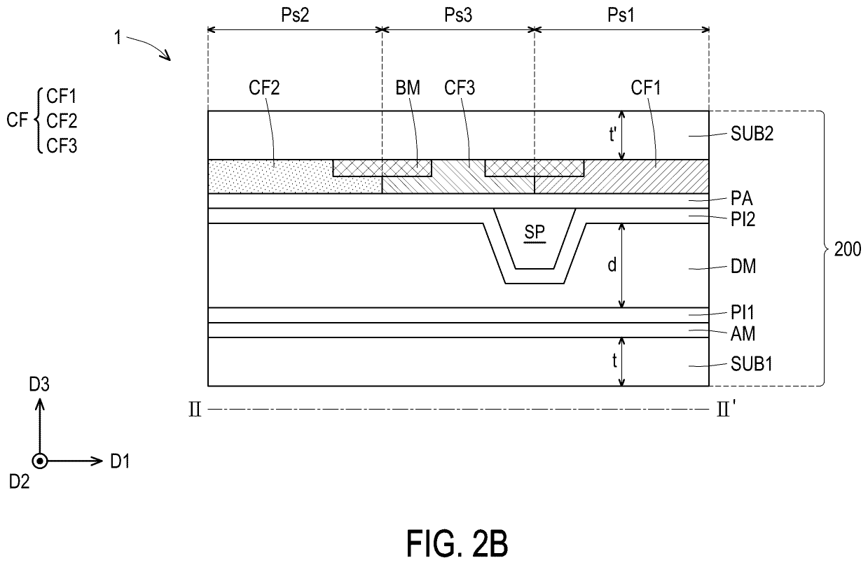

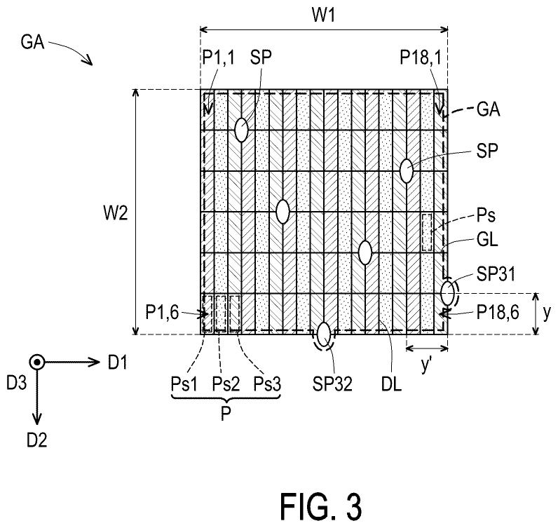

FIG. 1 is a schematic top view of an electronic device according to some embodiments of the disclosure. FIG. 2A and FIG. 2B are cross-sectional schematic views corresponding to section line I-I′ and section line II-II′ in FIG. 1, respectively. FIG. 3 to FIG. 5 are respectively partial top views of three electronic devices according to some embodiments of the disclosure, respectively illustrating three spacer groups and a plurality of sub-pixels thereunder.

Referring first to FIG. 1 to FIG. 2B, an electronic device 1 may include a display panel 200. The display panel 200 may include a first substrate SUB1, a second substrate SUB2, a display medium layer DM, a plurality of gate lines GL, a plurality of data lines DL, and a spacer layer. The spacer layer may include a first spacer group 10G and a second spacer group 20G. The second substrate SUB2 is opposite to the first substrate SUB1. The display medium layer DM is disposed between the first substrate SUB1 and the second substrate SUB2 and has a minimum thickness d and a maximum thickness d′. The plurality of gate lines GL are disposed on the first substrate SUB1 and extending along a first direction D1. The plurality of gate lines GL include a first gate line GL1 (see FIG. 1). The plurality of data lines DL are disposed on the first substrate SUB1 and extending along a second direction D2, wherein the plurality of gate lines GL are intersected with the plurality of data lines DL to define a plurality of sub-pixels Ps. The first direction D1 and the second direction D2 are different.

The first spacer group 10G and the second spacer group 20G are disposed between the first substrate SUB1 and the second substrate SUB2. As shown in FIG. 1, the first spacer group 10G and the second spacer group 20G are adjacently disposed along the first direction D1 and have the same spacer arrangement. The first spacer group 10G includes a first spacing unit SP1 overlapped with the first gate line GL1. In the first spacer group 10G, the first spacing unit SP1 has a first order on the first gate line GL1. The second spacer group 20G includes a second spacing unit SP2 overlapped with the first gate line GL1. In the second spacer group 20G, the second spacing unit SP2 has a first order on the first gate line GL1. In the first direction D1, the distance between the first spacing unit SP1 and the second spacing unit SP2 is a first distance DT1. The first distance DT1 may be measured at the same position of the first spacing unit SP1 and the second spacing unit SP2. For example, the distance between the center position of the first spacing unit SP1 and the center position of the second spacing unit SP2 is the first distance DT1. Alternatively, the distance between the left edge of the first spacing unit SP1 and the left edge of the second spacing unit SP2 is the first distance DT1.

According to some embodiments, the first distance DT1 may be designed to be less than a specific value, for example, less than a reference size m, m=k*y*[ln(t*d)+t/y], wherein k is equal to the minimum thickness of the display medium layer DM divided by the maximum thickness, y is the size of one of the plurality of sub-pixels in the second direction D2, t is the thickness of the first substrate, d is the minimum thickness of the display medium layer DM, and m, y, t and d have the same unit (for example, all are “μm”).

As shown in FIG. 1, a plurality of spacing units SP are disposed between the first substrate SUB1 and the second substrate SUB2. The plurality of spacing units SP may be divided into a plurality of spacer groups. One spacer group refers to the spacing units SP included in the minimum repeated region of the spacing units. Specifically, the spacing units in the first spacer group 10G and the second spacer group 20G are repeated. That is, the arrangement of the spacing units in the first spacer group 10G and the arrangement of the spacing units in the second spacer group 20G are the same. For the convenience of description, FIG. 1 shows a portion of the display panel 200, for example, only shows nine spacer groups, but the disclosure is not limited thereto.

According to some embodiments, as shown in FIG. 1, in the first direction D1, the first distance DT1 between the first spacing unit SP1 and the second spacing unit SP2 may be greater than three times the size of one sub-pixel (e.g., Ps1) of the plurality of sub-pixels in the first direction D1, that is, the first distance DT1 may be greater than a size y′. According to some embodiments, as shown in FIG. 1, in the first direction D1, the first distance DT1 between the first spacing unit SP1 and the second spacing unit SP2 may be greater than six times the size of one sub-pixel (e.g., Ps1) of the plurality of sub-pixels in the first direction D1, that is, the first distance DT1 may be greater than a size 2y′. Alternatively, DT1 may be greater than 9 times the size of one sub-pixel (e.g., Ps1) of the plurality of sub-pixels in the first direction D1, that is, the first distance DT1 may be greater than a size 3y′.

As shown in FIG. 1, the plurality of spacing units SP are disposed between the first substrate SUB1 and the second substrate SUB2. The plurality of spacing units SP are divided into a plurality of spacer groups. Each spacer group has the same spacer arrangement. Specifically, the first spacer group 10G and the second spacer group 20G are adjacently disposed along the first direction D1. The first spacer group 10G and the third spacer group 30G are adjacently disposed along the second direction D2. The first spacer group 10G, the second spacer group 20G, and the third spacer group 30G have the same spacer arrangement. The first spacer group 10G, the second spacer group 20G, and the third spacer group 30G respectively have the same number of spacing units SP. For example, the first spacer group 10G has four spacing units SP, but the disclosure is not limited thereto. According to some embodiments, each of the spacer groups G may include 2 to 50 spacing units SP, such as 2 to 30 spacing units SP, such as 3 to 20 spacing units SP, but the disclosure is not limited thereto. In the disclosure, the spacing unit SP may be a main spacer, a sub-spacer, or a combination thereof, without limitation.

In the disclosure, a spacing unit having a first order on a gate line indicates that the spacing unit is disposed at the first position on the gate line in a direction from the first data line to the last data line. There is no other spacing unit on the gate line before this spacing unit, and therefore this spacing unit is defined as the first-order spacing unit. For example, as shown in FIG. 1, in the first spacer group 10G, on the first gate line GL1, in the direction from the first data line to the last data line (i.e., in the direction D1), the first spacing unit SP1 is the spacing unit disposed at the first position, and before the first spacing unit SP1, there is no other spacing unit on the first gate line GL1. Therefore, the first spacing unit SP1 is defined as a first-order spacing unit on the first gate line GL1 in the first spacer group 10G.

Similarly, in the disclosure, a spacing unit having a first order on a data line indicates that the spacing unit is disposed at the first position on the data line in a direction from the first gate line to the last gate line. There is no other spacing unit on the data line before this spacing unit, and therefore this spacing unit is defined as the first-order spacing unit. For example, as shown in FIG. 1, in the third spacer group 30G, on the data line DL1, in the direction from the first gate line to the last gate line (i.e., in the direction D2), the third spacing unit SP3 is a spacing unit disposed at the first position, and before the third spacing unit SP3, there is no other spacing unit on the data line DL1. Therefore, the third spacing unit SP3 is defined as the first-order spacing unit on the data line DL1 in the third spacer group 30G.

According to different requirements, the electronic device 1 may further include other elements or film layers. Taking a liquid-crystal display device as an example, as shown in FIG. 2A or FIG. 2B, the electronic device 1 may further include an active element array layer AM, an alignment layer PI1, an alignment layer PI2, a passivation layer PA, a color filter layer CF, a black matrix layer BM, and a spacer layer. The spacer layer includes a plurality of spacing units SP. For the convenience of explanation, FIG. 2A and FIG. 2B schematically only illustrate one spacing unit SP.

In detail, the first substrate SUB1 and the second substrate SUB2 are overlapped in the thickness direction (e.g., the third direction D3) of the electronic device 1. The first substrate SUB1 and the second substrate SUB2 may be rigid substrates or flexible substrates. The material of the first substrate SUB1 includes, for example, glass, quartz, ceramic, sapphire, plastic, or a combination thereof, but the disclosure is not limited thereto. The plastic may include polycarbonate (PC), polyimide (PI), polypropylene (PP), polyethylene terephthalate (PET), other suitable flexible materials, or a combination of the above materials, but the disclosure is not limited thereto.

In some embodiments, the thickness t of the first substrate SUB1 may be in a range of 50 μm to 1500 μm, such as in a range of 100 μm to 1000 μm, such as in a range of 120 μm to 500 μm. For example, the thickness t of the first substrate SUB1 falls within the range of 100 μm to 500 μm, that is, 100 μm≤t≤500 μm. In some embodiments, the thickness t′ of the second substrate SUB2 may be in a range of 50 μm to 1500 μm, such as in a range of 100 μm to 1000 μm, such as in a range of 120 μm to 500 μm. For example, the thickness t′ of the first substrate SUB2 falls within the range of 100 μm to 500 μm. The thickness t and the thickness t′ may be measured by a vernier caliper. The relevant contents of the second substrate SUB2 are as provided for the first substrate SUB1 and are not repeated here. The first substrate SUB1 and the second substrate SUB2 may the same material or different materials. The thickness t and the thickness t′ may be the same or different without limitation.

The active element array layer AM is disposed on the first substrate SUB1 and located between the first substrate SUB1 and the alignment layer PI1. Although not shown, the active element array layer AM may include a plurality of conductive layers, a plurality of insulating layers, a plurality of active elements, and/or a plurality of passive elements. The conductive layer may be a patterned conductive layer, and the patterned conductive layer may include a conductive line, a conductive through hole, and/or a pad. The material of the conductive layer may include a transparent conductive material or an opaque conductive material. The material of the conductive layer may be metal, metal alloy, or a combination thereof. The transparent conductive material may include metal oxide, graphene, other suitable transparent conductive materials, or a combination thereof. The metal oxide may include indium tin oxide, indium zinc oxide, aluminum tin oxide, aluminum zinc oxide, indium germanium zinc oxide, or other metal oxides. The opaque conductive material may include metal, alloy, or a combination thereof. The material of the insulating layer includes, for example, an organic insulating material, an inorganic insulating material, or a combination thereof. Examples of the organic insulating material include polymethylmethacrylate (PMMA), epoxy, acrylic-based resin, silicone, polyimide polymer, or a combination thereof, but the disclosure is not limited thereto. The inorganic insulating material includes, for example, silicon oxide or silicon nitride, but the disclosure is not limited thereto. The active element may include a switch element, such as a thin-film transistor, but the disclosure is not limited thereto. The passive element may include a capacitor, a resistor, an inductor, or a combination thereof.

In some embodiments, the active element array layer AM may include a first patterned conductive layer (not shown) and a second patterned conductive layer (not shown). The first patterned conductive layer may include the plurality of gate lines GL, and the second patterned conductive layer may include the plurality of data lines DL. One or a plurality of insulating layers (not shown) may be disposed between the first patterned conductive layer and the second patterned conductive layer to maintain independent electrical properties.

As shown in FIG. 1, the first substrate SUB1 and/or the second substrate SUB2 may include an active region R1 and a peripheral region R2. The active region R1 and the peripheral region R2 are disposed adjacent to each other. For example, the peripheral region R2 may surround the active region R1, but the disclosure is not limited thereto. The plurality of gate lines GL and the plurality of data lines DL may be disposed in the active region R1 of the first substrate SUB1, wherein the plurality of gate lines GL are, for example, arranged along the second direction D2, and the plurality of data lines DL are, for example, arranged along the first direction D1. The first direction D1 and the second direction D2 may be perpendicular to each other, but the disclosure is not limited thereto. In some embodiments, although not shown in FIG. 1, the plurality of gate lines GL may be electrically connected to the gate driving circuit in the peripheral region R2 via some conductive lines in the peripheral region R2 of the first substrate SUB1. The plurality of data lines DL may be electrically connected to the source driving circuit in the peripheral region R2 via some other conductive lines in the peripheral region R2, but the disclosure is not limited thereto. According to some embodiments, the gate driving circuit may be disposed on the first substrate SUB1. Alternatively, the gate driving circuit may be disposed outside the first substrate SUB1. The source driving circuit may be disposed on the first substrate SUB1. Alternatively, the source driving circuit may be disposed outside the first substrate SUB1.

The plurality of gate lines GL and the plurality of data lines DL are intersected with each other to divide a plurality of sub-pixels Ps arranged in an array (one of which is schematically indicated in FIG. 1), and each sub-pixel Ps is, for example, surrounded by two adjacent gate lines GL and two adjacent data lines DL. In some embodiments, the plurality of sub-pixels Ps may include sub-pixels of a plurality of colors. Taking FIG. 1 as an example, the plurality of sub-pixels Ps may include a plurality of first-color sub-pixels Ps1, a plurality of second-color sub-pixels Ps2, and a plurality of third-color sub-pixels Ps3. The plurality of first color sub-pixels Ps1, the plurality of second color sub-pixels Ps2, and the plurality of third color sub-pixels Ps3 are alternately arranged along the first direction D1, for example, and a plurality of sub-pixels Ps of the same color are arranged along the second direction D2, for example, but the disclosure is not limited thereto. The first color, the second color, and the third color are different colors.

The colors of the first color sub-pixels Ps1, the second color sub-pixels Ps2, and the third color sub-pixels Ps3 may depend on color filter patterns of a plurality of different colors of the color filter layer CF, but the disclosure is not limited thereto. Taking FIG. 2A or FIG. 2B as an example, the color filter layer CF may include a plurality of first color filter patterns CF1 (one is schematically shown in FIG. 2A and FIG. 2B), a plurality of second color filter patterns CF2 (one is schematically shown in FIG. 2 and FIG. 2B), and a plurality of third color filter patterns CF3 (one is schematically shown in FIG. 2 and FIG. 2B). The plurality of first color filter patterns CF1, the plurality of second color filter patterns CF2, and the plurality of third color filter patterns CF3 are, for example, alternately arranged along the first direction D1, and a plurality of color filter patterns CF of the same color are, for example, arranged along the second direction D2, but the disclosure is not limited thereto.

In some embodiments, the first color filter pattern CF1 may be a red filter pattern allowing red light to pass through and filtering other color lights, the second color filter pattern CF2 may be a green filter pattern allowing green light to pass through and filtering other color lights, and the third color filter pattern CF3 may be a blue filter pattern allowing blue light to pass through and filtering other color lights; correspondingly, the first color sub-pixel Ps1, the second color sub-pixel Ps2, and the third color sub-pixel Ps3 are respectively a red sub-pixel, a green sub-pixel, and a blue sub-pixel, but the disclosure is not limited thereto.

In some embodiments, as shown in FIG. 1, the plurality of first color sub-pixels Ps1, the plurality of second color sub-pixels Ps2, and the plurality of third color sub-pixels Ps3 may form a plurality of pixels P (one of which is schematically shown in FIG. 1). Each of the pixels P may include one first color sub-pixel Ps1, one second color sub-pixel Ps2, and one third color sub-pixel Ps3. Correspondingly, the size (e.g., width) y′ of the pixel P in the first direction D1 is equal to the sum of the widths of the first color sub-pixel Ps1, the second color sub-pixel Ps2, and the third color sub-pixel Ps3 in the first direction D1, and the size (e.g., width) of the pixel P in the second direction D2 is equal to the size y of one sub-pixel Ps in the second direction D2. In some embodiments, the size (e.g., width) y′ of the pixel P in the first direction D1 is equal to three times the distance between two adjacent data lines DL in the first direction D1, and the size (e.g., width; equals to the size y) of the pixel P in the second direction D2 is equal to the distance between two adjacent gate lines GL in the second direction D2. In some embodiments, y′=y, but the disclosure is not limited thereto. In some embodiments, y is within the range of 10 μm to 1000 μm, for example, y is within the range of 15 μm to 500 μm, for example, y is within the range of 1 μ8m to 300 μm, that is, 18 μm≤y≤300 μm. The size (e.g., y′ or y) of the pixel P in the first direction D1 or the second direction D2 may be measured using an optical microscope, calculated by the size and the resolution of the active region R1, or calculated by the pixel density (pixels per inch, PPI). For example, if the size (diagonal length) of the active region R1 is 14 inches, and the resolution is 1920*1200 (i.e., the number of horizontal pixels is 1920 and the number of vertical pixels is 1200), according to the Pythagorean theorem, (1920*y)\hat{ }2+(1200*y)\hat{ }2=(14*25400)\hat{ }2, resulting in y=157.08 μm.

Referring again to FIG. 2A or FIG. 2B, the alignment layer PI1 is disposed on the active element array layer AM and located between the display medium layer DM (e.g., liquid-crystal layer) and the active element array layer AM. Moreover, the alignment layer PI2 is disposed on the second substrate SUB2 and located between the display medium layer DM (e.g., liquid-crystal layer) and the second substrate SUB2. The display medium layer DM is, for example, a liquid-crystal layer, and the alignment layer PI1 and the alignment layer PI2 may be used to control the arrangement direction of liquid-crystal molecules in the liquid-crystal layer and provide a pre-tilt angle of the liquid crystal. The material of the alignment layer PI1 and the alignment layer PI2 includes, for example, polyimide, but the disclosure is not limited thereto.

The display medium layer DM has a minimum thickness d and a maximum thickness d′. The minimum thickness d and the maximum thickness d′ of the display medium layer DM depend on the minimum value and the maximum value of the liquid-crystal gap, and the size of the liquid-crystal gap is related to the thickness (for example, the thickness of the alignment layer PI1, the thickness of the alignment layer PI2, the thickness of the active element array layer AM, the thickness of the color filter layer CF, the thickness of the black matrix layer BM, the thickness of the passivation layer PA, the thickness of the main spacing unit, the thickness of the sub-spacing unit, etc.) of the elements or the film layers disposed on the first substrate SUB1 and the second substrate SUB2 and/or the amount of liquid-crystal used, for example.

When actually measuring the liquid-crystal gap or the thickness of the display medium layer DM, a plurality of points may be selected in the active region R1 of the electronic device 1 and the plurality of points may be illuminated by an optical instrument to measure the liquid-crystal gaps or the thickness of the display medium layer DM respectively corresponding to the plurality of points. For example, three liquid-crystal gaps (or three thicknesses of the display medium layer DM) corresponding to three points in the active region R1 may be measured using an optical instrument, and then the maximum value and the minimum value are selected therefrom as the minimum thickness d and the maximum thickness d′. Taking FIG. 1 as an example, the liquid-crystal gap (or the thickness of the display medium layer DM) in the region in which section line I-I′ is located, the region in which section line II-II′ is located, and another region (not shown) may be measured. For example, the thickness d′ of the display medium layer DM measured in the region corresponding to section line I-I′ is 2.2 μm (see FIG. 2A), the thickness d measured in the region corresponding to section line II-II′ is 1.9 μm (see FIG. 2B), and the thickness measured in another region not shown is 2 μm. In this way, the minimum thickness d (see FIG. 2B) and the maximum thickness d′ (see FIG. 2A) of the display medium layer DM may be defined as 1.9 μm and 2.2 μm, respectively. According to other embodiments, an optical instrument may be used to measure more different positions in the active region R1 to measure different thickness values of the display medium layer DM. For example, three positions may be measured to obtain three different thicknesses, from which the maximum thickness and the minimum thickness of the display medium layer DM may be obtained. Alternatively, five positions may be measured to obtain five different thicknesses, from which the maximum thickness and the minimum thickness of the display medium layer DM may be obtained. According to some embodiments, the measurement positions may be different positions evenly distributed on the display panel 200, such as in the case of five positions, and the five positions may be at the center, upper left, lower left, upper right, and lower right of the display panel 200. There is no limitation on the number of the measurement positions. For example, the number of the measurement positions may be between 2 and 30, between 3 and 15, or between 3 and 9.

As shown in FIG. 2A and FIG. 2B, the positions where the maximum thickness and the minimum thickness of the display medium layer DM are measured are positions not overlapped with the spacing unit SP, and the maximum thickness and the minimum thickness of the display medium layer DM are the distances between the alignment layer PI1 and the alignment layer PI2.

The black matrix layer BM is disposed on the second substrate SUB2 and located between the second substrate SUB2 and the color filter layer CF. The black matrix layer BM may be used to absorb leaked light or improve light mixing. The material of the black matrix layer BM may include carbon black and black photoresist, but the disclosure is not limited thereto.

The passivation layer PA is disposed on the color filter layer CF and located between the alignment layer PI2 and the color filter layer CF. The passivation layer PA may be used to protect the color filter layer CF (e.g., to prevent scratching, water, and oxygen). The material of the passivation layer PA may include an inorganic insulating material, but the disclosure is not limited thereto.

The spacing unit SP is disposed on the passivation layer PA and located between the display medium layer DM and the passivation layer PA. The spacing unit SP may be a main spacing unit, a sub-spacing unit, or a combination thereof without limitation. The thickness of the main spacing unit is greater than the thickness of the sub-spacing unit. The main spacing unit may be used to maintain the liquid-crystal gap or provide a main structural support, and the sub-spacing unit may provide additional structural support when the electronic device 1 is pressed. When observed using an optical microscope, the main spacing unit and the sub-spacing unit may be distinguished by parameters such as the shape and the size of the spacer.

The plurality of spacing units SP arranged in the active region R1 may be divided into a plurality of spacer groups G having the same spacer arrangement. In other words, the plurality of spacing units SP in each of the spacer groups G have the same number and relative arrangement relationship. For ease of understanding, FIG. 1 schematically illustrates nine spacer groups G, each of the spacer groups G is overlapped with twenty-four pixels P, each of the spacer groups G includes four spacing units SP, and the four spacing units SP in each of the spacer groups G have the same relative arrangement relationship. It should be understood that, the number of spacer groups G, the number of pixels P overlapped by each of the spacer groups G, and/or the number of spacing units SP included in each of the spacer groups G may be changed according to actual needs and is not limited to what is shown in FIG. 1. In addition, the spacer group G herein is, for example, grouping of a plurality of spacing units SP.

For adjacent spacer groups G, the distance between two spacing units may be properly designed to ensure the stability of the two substrates. Specifically, as shown in FIG. 1, for adjacent spacer groups (e.g., the first spacer group 10G and the second spacer group 20G), the first distance DT1 between the first spacing unit SP1 of the first order in the first spacer group 10G and the second spacing unit SP2 of the first order in the second spacer group 20G may be appropriately designed to ensure the stability of the two substrates (the first substrate SUB1 and the second substrate SUB2) in the display panel 200. By properly designing the spacing between the spacing units, the two substrates (the first substrate SUB1 and the second substrate SUB2) may remain stable even when pressed or transported to avoid or reduce the possibility of generating mura. The above method of designing the spacing between the appropriate spacing units may adopt simulation results, experimental design, experimental planning, and/or statistical analysis to design a suitable spacing between the spacing units. By making the distance between the corresponding spacing units SP of the adjacent spacer groups G less than the reference size m, the issue of mura may be alleviated.

For example, the issue of mura may be alleviated by making the distance between corresponding spacing units SP of two adjacent spacer groups G in the first direction D1 less than the reference dimension m. Taking FIG. 1 as an example, the first spacer group 10G and the second spacer group 20G are adjacently disposed along the first direction D1, wherein the first spacing unit SP1 in the first spacer group 10G and the second spacing unit SP2 in the second spacer group 20G are both overlapped with the first gate line GL1, and in the first spacer group 10G and the second spacer group 20G, the first spacing unit SP1 and the second spacing unit SP2 respectively have a first order on the first gate line GL1. For example, in the first spacer group 10G, the first spacing unit SP1 is the first one overlapped with the first gate line GL from left to right, and in the second spacer group 20G, the second spacing unit SP2 is the first one overlapped with the first gate line GL from left to right. By making the first distance DT1 between the first spacing unit SP1 and the second spacing unit SP2 in the first direction D1 less than the reference dimension m, the issue of mura is alleviated.

For example, if y=180 μm, d=2.2 μm, d′=2.4 μm, k=0.917, and t=150 μm, then according to the equation m=k*y*[ln(t*d)+t/y], it may be calculated that m=1094.35 μm. That is, the issue of mura may be alleviated by making the first distance DT1 less than 1094.35 μm. Taking FIG. 1 as an example, the first distance DT1 may be designed to be 1080 μm (for example, 6 times y or y′), so as to be less than the above m value. Therefore, each of the spacer groups G may be overlapped with six pixels P in the first direction D1. In other words, a width W1 of the spacer group G in the first direction D1 may be equal to the sum of the widths of the six pixels P, and the width W1 of the spacer group G in the first direction D1 may be equal to the first distance DT1, for example.

Similarly, by design, the issue of mura may be alleviated by making the distance between corresponding spacing units SP of two adjacent spacer groups G in the second direction D2 less than the reference dimension m. Taking FIG. 1 as an example, the electronic device 1 may further include a third spacer group 30G, and the third spacer group 30G is disposed between the first substrate SUB1 and the second substrate SUB2 and has the same spacer arrangement as that of the first spacer group 10G and the second spacer group 20G, wherein the plurality of data lines DL include the first data line DL1, the third spacer group 30G includes the third spacing unit SP3 overlapped with the first data line DL1. In the third spacer group 30G, the third spacing unit SP3 has a first order on the first data line DL1 (for example, in the third spacer group 30G, the third spacing unit SP3 is the first one overlapped with the first data line DL1 from top to bottom), and in the second direction D2, the second distance DT2 between the first spacing unit SP1 and the third spacing unit SP3 may be designed to be less than the reference dimension m. By making the second distance DT2 between the first spacing unit SP1 and the third spacing unit SP3 in the second direction D2 less than the reference dimension m, the issue of mura is also alleviated.

For example, according to the above calculation, m=1094.35 μm is obtained. The issue of mura may be alleviated by making the second distance DT2 less than 1094.35 μm. Taking FIG. 1 as an example, the second distance DT2 may be designed to be 720 μm (for example, 4 times y or y′), so as to be less than the above m value. Therefore, each of the spacer groups G may be overlapped with four pixels P in the second direction D2. In other words, the width W2 of the spacer group G in the second direction D2 may be equal to the sum of the widths of the four pixels P, and the width W2 of the spacer group G in the second direction D2 may be equal to the second distance DT2, for example.

In addition, according to different design requirements, the second distance DT2 between the first spacing unit SP1 and the third spacing unit SP3 may be different from the first distance DT1 between the first spacing unit SP1 and the second spacing unit SP2. That is, the width W2 of the spacer group G in the second direction D2 may be different from the width W1 of the spacer group G in the first direction D1. However, in other embodiments, although not shown in FIG. 1, the second distance DT2 may be equal to the first distance DT1, for example, DT2=DT1=1080 μm, and each of the spacer groups G is overlapped with six pixels P in the first direction D1 and the second direction D2.

In FIG. 1, the first spacer group 10G further includes a fourth spacing unit SP4, the second spacer group 20G further includes a fifth spacing unit SP5, the plurality of gate lines GL further include a second gate line GL2 disposed adjacent to the first gate line GL1, and the fourth spacing unit SP4 and the fifth spacing unit SP5 are overlapped with the second gate line GL2 and adjacently disposed on the second gate line GL2.

In FIG. 1, the first spacer group 10G includes the plurality of spacing units SP, and each of the plurality of spacing units is overlapped with a different gate line GL in the plurality of gate lines GL. In addition, the first spacer group 10G includes a plurality of spacing units (e.g., the plurality of spacing units SP), and each of the plurality of spacing units is overlapped with a different data line DL in the plurality of data lines DL. Via the above design, the distribution uniformity of the spacing units SP may be improved, the regional difference of the liquid-crystal gap may be reduced, or the display quality may be improved.

However, in other embodiments, although not shown in FIG. 1, in any of the first spacer group 10G and the second spacer group 20G, at least two of the plurality of spacing units SP may be overlapped with one gate line GL or overlapped with one data line DL to simplify the design or enhance the regional structural strength.

Referring to FIG. 3, the main differences between the spacer group GA and the spacer group G of FIG. 1 are described as follows. For ease of illustration, FIG. 3 only shows one spacer group. In FIG. 3, the width W2 of the spacer group GA in the second direction D2 is the same as the width W1 of the spacer group GA in the first direction D1, and the width W1 and the width W2 are equal to the sum of the widths of six pixels P, for example. In addition, the number of spacing units SP included in the spacer group GA is six, wherein the six spacing units SP are respectively overlapped with different gate lines GL in the plurality of gate lines GL, and the six spacing units SP are respectively overlapped with different data lines DL in the plurality of data lines DL.

FIG. 3 shows one spacer group GA, and the spacer group GA corresponds to sub-pixels of 18 columns and 6 rows. In FIG. 3, the sub-pixel Px,y is defined as the sub-pixel in the x-th column and the y-th row. That is, the sub-pixel P1,1 is the sub-pixel in the 1st column and the 1st row, and the sub-pixel P18,1 is the sub-pixel in the 18th column and the 1st row, the sub-pixel P1,6 is the sub-pixel in the 1st column and the 6th row, and the sub-pixel P18,6 is the sub-pixel in the 18th column and the 6th row. The dotted line dividing the spacer group GA covers the spacing unit SP31 at the farthest edge (rightmost). Therefore, the edge of the dotted line exceeds the outermost (rightmost) sub-pixel unit and covers the sub-pixel unit not shown (e.g., P19,6 which is not shown) at the right side of the spacing unit SP31. The sub-pixel unit P18,6 and the sub-pixel unit P19,6 are adjacent to each other in the first direction D1. However, when measuring the width W1 of the spacer group GA in the first direction D1, the width between the sub-pixel unit P1,6 and the sub-pixel unit P18,6 is measured, or the width between the sub-pixel unit P1,1 and the sub-pixel unit P18,1 is measured.

Similarly, the dotted line dividing the spacer group GA covers the spacing unit SP32 at the outermost edge (bottommost). Therefore, the edge of the dotted line exceeds the bottom sub-pixel unit and covers the sub-pixel unit (e.g., P9,7 not shown). The sub-pixel unit P9,7 and the sub-pixel unit P9,6 are adjacent to each other in the second direction D2. However, when measuring the width W2 of the spacer group GA in the second direction D2, the width between the sub-pixel unit P1,1 and the sub-pixel unit P1,6 is measured, or the width between the sub-pixel unit P18,1 and the sub-pixel unit P18,6 is measured.

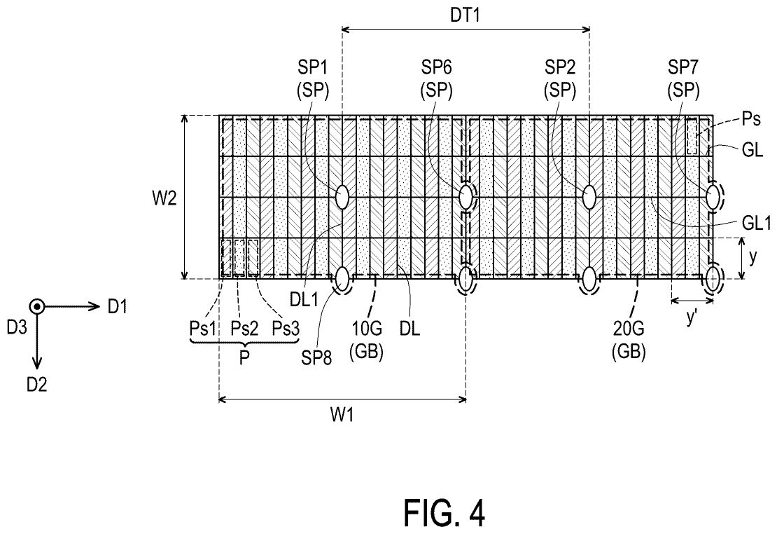

Referring to FIG. 4, the main differences between the spacer group GB and the spacer group G of FIG. 1 are described as follows. For the convenience of explanation, FIG. 4 schematically illustrates two spacer groups GB, which are respectively referred to as a first spacer group 10G and a second spacer group 20G. In FIG. 4, the number of the spacing units SP included in the spacer group GB is four, and two of the four spacing units SP are overlapped with one gate line GL or overlapped with one data line DL. Specifically, the first spacer group 10G further includes a sixth spacing unit SP6, the sixth spacing unit SP6 is overlapped with the first gate line GL1, and on the first gate line GL1, the sixth spacing unit SP6 may be disposed between the first spacing unit SP1 of the first spacer group 10G and the second spacing unit SP2 of the second spacer group 20G. The second spacer group 20G further includes a seventh spacing unit SP7, the seventh spacing unit SP7 is overlapped with the first gate line GL1, and the second spacing unit SP2 may be disposed between the sixth spacing unit SP6 and the seventh spacing unit SP7.

As shown in FIG. 4, according to some embodiments, the first spacer group 10G may further include an eighth spacing unit SP8, and the eighth spacing unit SP8 is overlapped with the first data line DL1. That is, in the first spacer group 10G, the first spacing unit SP1 and the eighth spacing unit SP8 are overlapped with the first data line DL1, and the first spacing unit SP1 is first in order on the first data line DL1. In the second direction D2, a third spacer group (not shown) may also be included, and the third spacer group may also include a first-order spacing unit (not shown, for example, referred to as the third spacing unit SP3) on the first data line DL1. As such, on the first data line DL1, the eighth spacing unit SP8 may be disposed between the first spacing unit SP1 and the third spacing unit SP3. In FIG. 4, the method of measuring the width W1 and the width W2 of one spacer group is as provided in the related description in FIG. 3, and is not be repeated here.

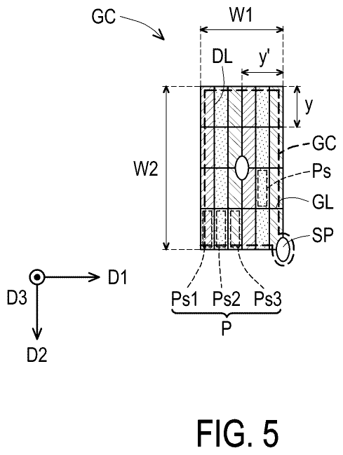

Referring to FIG. 5, the main differences between the spacer group GC and the spacer group G of FIG. 1 are described as follows. For ease of illustration, FIG. 5 only shows one spacer group. In FIG. 5, the width W1 of the spacer group GC in the first direction D1 is equal to the sum of the widths of two pixels P, for example. In addition, the number of spacing units SP included in the spacer group GC is two, wherein the two spacing units SP are respectively overlapped with different gate lines GL in the plurality of gate lines GL, and the two spacing units SP are respectively overlapped with different data lines DL in the plurality of data lines DL. In FIG. 5, the method of measuring the width W1 and the width W2 of one spacer group is as provided in the related description in FIG. 3, and is not be repeated here.

Based on the above, in an embodiment of the disclosure, the electronic device includes a plurality of spacer groups having the same spacing unit arrangement. The proper design of the distance between corresponding spacing units in adjacent spacer groups is helpful to maintain the stability of the display panel and alleviate the issue of color non-uniformity (such as mura).

Each of the above embodiments is used to describe the technical solutions of the disclosure and is not intended to limit the disclosure; and although the disclosure is described in detail via each of the above embodiments, those having ordinary skill in the art should understand that: modifications may still be made to the technical solutions recited in each of the above embodiments, or portions or all of the technical features thereof may be replaced to achieve the same or similar results; the modifications or the replacements do not make the nature of corresponding technical solutions depart from the scope of the technical solutions of each of the embodiments of the disclosure.

Although the embodiments of the disclosure and the advantages thereof are disclosed above, it should be understood that anyone having ordinary skill in the art may make changes, substitutions, and modifications without departing from the spirit and the scope of the disclosure, and the features between the various embodiments may be arbitrarily mixed and replaced with each other to form other new embodiments. In addition, the scope of the disclosure is not limited to the processes, machines, manufactures, material compositions, devices, methods, and steps in the specific embodiments described in the specification. Anyone having ordinary skill in the art may understand the current or future developed processes, machines, manufactures, material compositions, devices, methods, and steps from the content disclosed in the disclosure. As long as substantially the same functions may be implemented or substantially the same results may be achieved in the embodiments described herein, they may be used according to the disclosure. Therefore, the scope of the disclosure includes the above processes, machines, manufacture, material compositions, devices, methods, and steps. In addition, each claim constitutes a separate embodiment, and the scope of the disclosure also includes the combination of various claims and embodiments. The scope of the disclosure shall be determined by the scope of the accompanying claims.

What is claimed is:

1. An electronic device, comprising:
a first substrate;
a second substrate opposite to the first substrate;
a display medium layer disposed between the first substrate and the second substrate and having a minimum thickness and a maximum thickness;
a plurality of gate lines disposed on the first substrate and extending along a first direction, the plurality of gate lines comprising a first gate line;
a plurality of data lines disposed on the first substrate and extending along a second direction, wherein the plurality of gate lines are intersected with the plurality of data lines to define a plurality of sub-pixels, and the first direction and the second direction are different; and
a first spacer group and a second spacer group disposed between the first substrate and the second substrate, wherein the first spacer group and the second spacer group are adjacently disposed along the first direction and have a same spacer arrangement,
wherein the first spacer group comprises a first spacing unit overlapped with the first gate line, and in the first spacer group, the first spacing unit has a first order on the first gate line,
wherein the second spacer group comprises a second spacing unit overlapped with the first gate line, and in the second spacer group, the second spacing unit has a first order on the first gate line,
wherein in the first direction, a first distance between the first spacing unit and the second spacing unit is less than a reference size m,
$$m = k * y * [ ln ( t * d ) + t / y ] ,$$
wherein k is equal to the minimum thickness of the display medium layer divided by the maximum thickness, y is a size of one sub-pixel of the plurality of sub-pixels in the second direction, t is a thickness of the first substrate, d is the minimum thickness of the display medium layer, and m, y, t, and d have a same unit.

2. The electronic device of claim 1, wherein 100 μm≤t≤500 μm.

3. The electronic device of claim 1, wherein a thickness of the second substrate falls within a range of 100 μm to 500 μm.

4. The electronic device of claim 1, wherein 18 μm≤y≤300 μm.

5. The electronic device of claim 1, further comprising:
a third spacer group disposed between the first substrate and the second substrate and having a same spacer arrangement as the first spacer group and the second spacer group,
wherein the plurality of data lines comprise a first data line, the first spacing unit of the first spacer group is overlapped with the first data line, in the first spacer group, the first spacing unit has a first order on the first data line, the third spacer group comprises a third spacing unit overlapped with the first data line, and in the third spacer group, the third spacing unit has a first order on the first data line,
wherein in the second direction, a second distance between the first spacing unit and the third spacing unit is less than the reference size m.

6. The electronic device of claim 5, wherein the first distance and the second distance are different.

7. The electronic device of claim 1, wherein on the first gate line, the first spacing unit of the first spacer group and the second spacing unit of the second spacer group are adjacently disposed along the first direction.

8. The electronic device of claim 1, wherein:
the first spacer group further comprises a fourth spacing unit, the second spacer group further comprises a fifth spacing unit, and the plurality of gate lines further comprise a second gate line disposed adjacent to the first gate line,
the fourth spacing unit and the fifth spacing unit are overlapped with the second gate line and adjacently disposed on the second gate line.

9. The electronic device of claim 1, wherein the first spacer group comprises a plurality of spacing units, the plurality of spacing units comprise the first spacing unit, and the plurality of spacing units are overlapped with different gate lines in the plurality of gate lines respectively.

10. The electronic device of claim 9, wherein the plurality of spacing units are overlapped with different data lines in the plurality of data lines respectively.

11. The electronic device of claim 1, wherein the first spacer group comprises a plurality of spacing units, the plurality of spacing units comprise the first spacing unit, and the plurality of spacing units are overlapped with different data lines in the plurality of data lines respectively.

12. The electronic device of claim 1, wherein the first spacer group further comprises a sixth spacing unit, the sixth spacing unit is overlapped with the first gate line, and on the first gate line, the sixth spacing unit is disposed between the first spacing unit and the second spacing unit.

13. The electronic device of claim 1, wherein in the first direction, the first distance between the first spacing unit and the second spacing unit is greater than 3 times a size of one sub-pixel of the plurality of sub-pixels in the first direction.

14. The electronic device of claim 1, wherein in a top view, the first spacing unit and the second spacing unit are respectively located at two intersections of the plurality of gate lines and the plurality of data lines.

15. The electronic device of claim 1,
wherein the plurality of sub-pixels comprises a first sub-pixel group and a second sub-pixel group disposed adjacently along the first direction, the first spacer group is overlapped with the first sub-pixel group, and the second spacer group is overlapped with the second sub-pixel group, and
wherein the first spacer group comprises another spacing unit disposed at a boundary between the first sub-pixel group and the second sub-pixel group.

16. The electronic device of claim 1, further comprising:
a third spacer group disposed between the first substrate and the second substrate and having a same spacer arrangement as the first spacer group and the second spacer group, wherein the first spacer group and the third spacer group are adjacently disposed along the second direction,
wherein the plurality of sub-pixels comprises a first sub-pixel group and a third sub-pixel group disposed adjacently along the second direction, the first spacer group is overlapped with the first sub-pixel group, and the third spacer group is overlapped with the third sub-pixel group, and
wherein the first spacer group comprises another spacing unit disposed at a boundary between the first sub-pixel group and the third sub-pixel group.

17. The electronic device of claim 1, wherein in a top view, a shortest distance between any two spacing units in the first spacer group is greater than y.

18. The electronic device of claim 1, wherein in the second direction, a distance between two adjacent gate lines in the plurality of gate lines is equal to y.

19. The electronic device of claim 1, wherein the display medium layer comprises a liquid-crystal layer.

20. The electronic device of claim 19, wherein the minimum thickness and the maximum thickness of the display medium layer are a minimum value and a maximum value of a plurality of liquid-crystal gap values measured at a plurality of positions of the electronic device.
